(19) United States
(12) Patent Application Publication
(10) Pub. No.: US 2008/0120337 A1
(43) Pub. Date: May 22, 2008

(54) Method And System For Performing Data Operations Using A Publish/Subscribe Service

(76) Inventor: Jared S. Fry, Boston, MA (US)

Correspondence Address: SCENERA RESEARCH, LLC, 111 CORNING RD., SUITE 220, CARY, NC, 27511, US

(21) Appl. No.: 11/561,913

(22) Filed: Nov. 21, 2006

(51) Int. Cl. G06F 17/30

(52) U.S. Cl. 707/104.1; 707/E17.002

(57) ABSTRACT

A method for performing data operations using a publish/subscribe service includes providing a first tuple that includes data operation information that is configured to operate on a source data, providing for a first subscription by the first tuple to a second tuple that includes the source data, and providing for a second subscription by a subscriber to the first tuple. A notification indicating an update of the source data of the second tuple is received pursuant to the first subscription and in response to receiving the notification, resultant data is generated using the data operation information of the first tuple to process at least the updated source data of the second tuple. Thereafter, a notify message including the resultant data is generated.

### COPYRIGHT NOTICE

A portion of the disclosure of this patent document contains material which is subject to copyright protection. The copyright owner has no objection to the facsimile reproduction by anyone of the Patent and Trademark Office patent file or records, but otherwise reserves all copyright rights whatsoever.

### BACKGROUND

More and more, users of electronic devices are exchanging digital information asynchronously, i.e., in substantially real time, over the Internet using asynchronous communication protocols. Unlike traditional communication protocols, such as HyperText Transport Protocol (HTTP), the commands of an asynchronous protocol, such as publish/subscribe (pub/sub) communication protocols, are structured such that there need not be a one-to-one correspondence between requests and responses exchanged between the devices. In some cases a sender of information via the protocol need not wait, nor expect a response from, a receiver. Moreover, a receiver need not send a request for each response. That is, a receiver may receive multiple responses to a request and/or may receive an unsolicited message. Thus, unlike HTTP where the reply is sent directly (synchronously) and only in response to the entity's request, the information can instead be sent in response to the sender's posting of the information (i.e., asynchronous to the request of information).

According to pub/sub communication protocols, an entity, referred to as a subscriber or subscriber client, is allowed to subscribe to information provided by another entity, referred to as a publisher, via a pub/sub service. Publishers publish to a distinct ID, typically a uniform resource identifier (URI) or uniform resource locator URL, and subscribers subscribe by providing the ID. The publisher posts, i.e., publishes, the information to the pub/sub service identifying the tuple to be created or updated, the service then transmits the published tuple information to all interested parties, i.e., subscribers, via notification messages. The published information can be read simultaneously by any number of subscribers. So long as the subscriber remains subscribed to the information, the subscriber will continue to receive notification messages corresponding to the publisher's postings.

Notably, as is used herein, the term “publish/subscribe” refers to the class of services and associated protocols where a subscriber receives only the most recently published information in a notification message resulting from a subscription. That is, the pub/sub service transmits to the subscriber only the most current state of the published information, and does not queue, or store, previously published data for retrieval when the subscriber is offline or otherwise unsubscribed, such as with email and traditional message queues. Thus, unlike typical message queuing services, when a subscriber logs on or subscribes to the pub/sub service, the subscriber receives only the current state of the information, as well as subsequent updates to the information while the subscriber is subscribed. The subscriber does not receive previous updates that may have occurred while the subscriber was offline or unsubscribed. In addition, the pub/sub services as described herein are not topic based subscription services where typically any number of publishers may contribute to a single subscription. In topic based subscription services, whether a published entity is sent to a subscriber is based on its topic or categorization. Such topic based subscription services are also sometimes referred to as pub/sub services.

Once the subscriber receives the notification message that includes the published information, the subscriber can use the published information in a number of ways. For example, the information can be translated, used in a calculation, or used as input into different types of executed functions, such as in automated processes. In some instances, the information can be manipulated to change its format so that it can be used by a specific application or so that it can be stored more efficiently. For example, the published information can be the current temperature in Boston in degrees-Fahrenheit, and the subscriber's client device can perform a data operation to convert the temperature from degrees-Fahrenheit to degrees-Celsius.

Typically, this processing or manipulation of the published information takes place on the subscriber's client device. Accordingly, the processed information resides locally on the client device. When the subscriber wishes to share the processed information with other clients, the subscriber can act as a publisher and post the processed information to the pub/sub service identifying the tuple to be created or updated, and the pub/sub service can transmit the processed information to the interested parties, i.e., subscribers, via notification messages. Alternatively, or in addition, the processed information can be transmitted to others through some other means outside of the pub/sub service.

This process of receiving published information, processing the published information, and then posting the processed information is time consuming and inefficient. It requires the subscriber/publisher to coordinate subscriptions, which can be tedious and burdensome. Moreover, because the data operation is performed at the client, the client must establish another communication channel with the pub/sub service to post the processed information to the pub/sub service. Again, these additional steps are time-consuming and inefficient.

### SUMMARY

Accordingly, a system and method for performing data operations using a pub/sub service are described. According to an exemplary embodiment, a method includes providing a first tuple that includes data operation information that is configured to operate on a source data, providing for a first subscription by the first tuple to a second tuple that includes the source data, and providing for a second subscription by a subscriber to the first tuple. A notification indicating an update of the source data of the second tuple is received pursuant to the first subscription and in response to receiving the notification, resultant data is generated using the data operation information of the first tuple to process at least the updated source data of the second tuple. Thereafter, a notify message including the resultant data is generated.

According to another exemplary embodiment, a system is described for performing data operations using a pub/sub service that includes a publication handler that provides a first tuple that includes data operation information that is configured to operate on a source data, an input watcher component that initiates a first subscription by the first tuple to a second tuple that includes the source data and that receives, pursuant to the first subscription, a notification indicating an update of the source data of the second tuple, and a subscription handler that provides for a second subscription by a subscriber to the first tuple. The system also includes a function executor component that generates resultant data using the data operation information of the associated first tuple to process at least the updated source data of the second tuple in response to receiving the notification, and a notification handler for generating a notify message including the resultant data.

### BRIEF DESCRIPTION OF THE DRAWINGS

The accompanying drawings provide visual representations which will be used to more fully describe the representative embodiments disclosed here and can be used by those skilled in the art to better understand them and their inherent advantages. In these drawings, like reference numerals identify corresponding elements, and:

FIG. 1 is a block diagram illustrating an exemplary system for performing data operations using a pub/sub service according to an exemplary embodiment;

FIG. 2 is a block diagram illustrating an exemplary pub/sub service according to an exemplary embodiment;

FIG. 3 is an exemplary data model representing a function tuple according to one embodiment;

FIG. 4 is a block diagram illustrating an exemplary function handler according to one embodiment; and

FIG. 5 is a flow diagram illustrating a method for performing data operations using the pub/sub service according to an exemplary embodiment.

### DETAILED DESCRIPTION

Various aspects will now be described in connection with exemplary embodiments, including certain aspects described in terms of sequences of actions that can be performed by elements of a computing device or system. For example, it will be recognized that in each of the embodiments, at least some of the various actions can be performed by specialized circuits or circuitry (e.g., discrete and/or integrated logic gates interconnected to perform a specialized function), by program instructions being executed by one or more processors, or by a combination of both. Thus, the various aspects can be embodied in many different forms, and all such forms are contemplated to be within the scope of what is described.

According to an exemplary embodiment, a method and system for performing data operations using a pub/sub service is described. A pub/sub communication architecture and its underlying messaging protocol allow published information to be sent to a subscriber as it is received, in many instances, substantially in real-time in relation to the publication of the information. Information is published within the pub/sub communication architecture using a publish command. The published information can then be communicated to a subscriber using a notify command. The notify command can either include the published information or can provide a reference to the published information.

Well known pub/sub communication protocols include presence protocols, such as XMPP-IM, SIP SIMPLE, and RVP, which are used by presence services, and Jabber Software Foundation's pub/sub protocol as specified in Jabber Enhancement Proposal (JEP) JEP0060: Publish-Subscribe. The architecture, models, and protocols associated with presence services in general are described in “Request for Comments” (or RFC) documents RFC 2778 to Day et al., titled “A Model for Presence and Instant Messaging” (February 2000), RFC 2779 to Day et al., titled “Instant Messaging/Presence Protocol” (February 2000), and RFC 3921 to Saint-Andre et. al, titled “Extensible Messaging and Presence Protocol (XMPP): Instant Messaging and Presence”, each of which are published and owned by the Internet Society and incorporated here in their entirety by reference.

Generally speaking, one or more pub/sub servers are used to provide pub/sub services. The function of a pub/sub server, however, can be incorporated, either in whole or in part, into other entities. For example, according to the presence service model described in RFC 2778, two distinct agents of a presence service client are defined. The first of these agents, called a “presentity” (combining the terms “presence” and “entity”), provides presence information to be stored and distributed throughout the presence service on behalf of a presence client. The second type of presence agent is referred to as a “watcher”. Watchers receive presence information from a presence service on behalf of a presence client.

The presence model of RFC 2778 describes two types of watchers, referred to as “subscribers” and “fetchers”. A subscriber requests notification from the presence service of a change in some presentity client's presence information. The presence service establishes a subscription on behalf of the subscriber to a presentity client's presence information, such that future changes in the presentity client's presence information are “pushed” to the subscriber. In contrast, the fetcher class of watchers requests (or fetches) the current value of some presentity client's presence information from the presence service. As such, the presence information can be said to be “pulled” from the presence service to the watcher.

Users of the presence service are referred to in the presence model described in RFC 2778 as principals. Typically, a principal is a person or group that exists outside of the presence model, but can also represent software or other resources capable of interacting with the presence service. A principal can interact with the presence system through a presence user agent (PUA) or a watcher user agent (WUA). As in the case of the presentity and watcher clients with which these service clients interact, the presence and watcher user agents can be combined functionally as a single user agent having both the characteristics of the presence and watcher user agents. User agents can be implemented such that their functionality exists within a presence service, external to a presence service, or a combination of both. Similar statements can be made about presentities and watchers.

By way of example, aspects of an exemplary embodiment described here can employ a presence protocol as the pub/sub communication protocol. It should be understood, however, the relevant techniques described here can be performed using any pub/sub communications protocol as defined herein. Additionally, the exemplary embodiment described herein is not limited to the use of a pub/sub protocol for all communications described. Other known protocols can also be used.

According to pub/sub communication protocols, the pub/sub service stores and organizes information provided by the publisher and by the subscriber in data entities referred to as tuples. A tuple, in its broadest sense, is a data object containing one or more elements. If a tuple contains a status element it is referred to as a presence tuple (RFC 2778) and the information stored in the status element is referred to as presence information. A pub/sub service which processes presence tuples is referred to as a presence service. In addition to containing a status element, a presence tuple can include any other content.

A tuple can represent any element used to store the published information associated with a publisher or principal. The published information may include general contact information of the publisher, such as name, telephone number, email address, postal address, an IP addresses or URLs associated with the publisher, and the like, as well as other data or content. As used here, the tuple can also be a representation that maps field names to certain values to indicate that an entity or object (e.g., the principal) includes certain components, information, and/or perhaps has certain properties.

According to aspects of an exemplary embodiment, data operation information is published and stored in a tuple, and managed by the pub/sub service. In this description, such a tuple is referred to as a function tuple. The data operation information represents a process or function that is configured to be performed on one or more source data inputs, which are referenced in the data operation information. In one embodiment, the pub/sub service is configured to perform the process or function, and the resultant data is provided to a subscriber of the function tuple. In one embodiment, the resultant data is not limited to a single output, but can include multi-value outputs depending on the process or function. Accordingly, the data to which the subscriber is subscribing includes the resultant data and does not necessarily include the data operation information, which is being published by the publisher.

In an exemplary embodiment, the source data inputs can include data stored in one or more tuples, herein referred to as tuple data. The one or more tuples can be managed by the pub/sub service that manages the function tuple, or by another pub/sub service on another server. According to one embodiment, the function tuple can subscribe to the one or more tuples so that it can be notified of updates to the tuple data. When such an update is received, the data operation information in the function tuple can be applied to the one or more source data inputs, including the updated tuple data, to generate the resultant data. Accordingly, the resultant data sent to the subscriber can be up-to-date.

By providing the function tuple at the pub/sub service, the data processing function can be performed at a central location by the pub/sub service instead of at a remote location by a pub/sub client. The processed information can be distributed to subscribers directly from the pub/sub service. Redundant processing performed in multiple pub/sub clients is greatly reduced. Accordingly, performance and efficiency is improved.

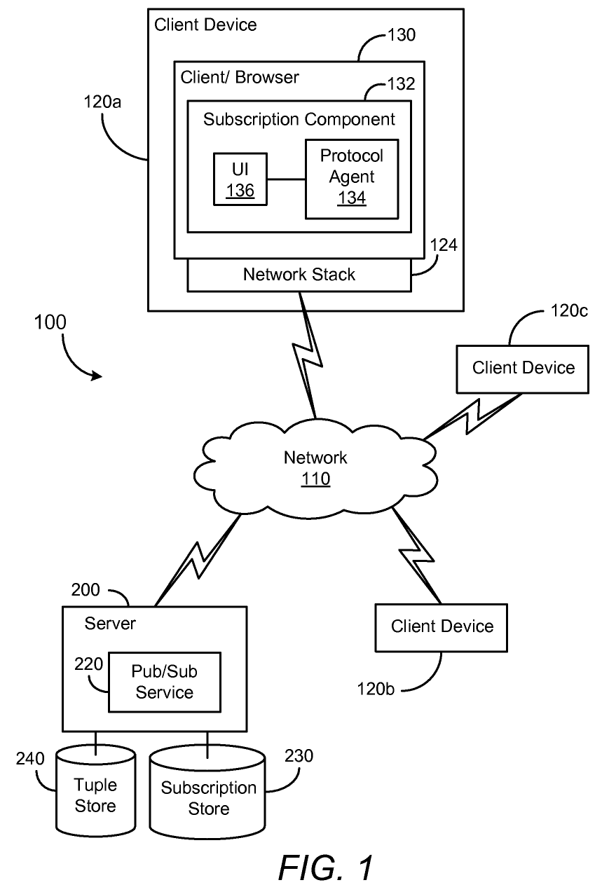

FIG. 1 is a block diagram illustrating an exemplary system for performing data operations using a pub/sub service according to an exemplary embodiment. The system 100 includes a plurality of devices 120a, 120b, 120c in communication with a server 200 that hosts a pub/sub service 220. The device, e.g., 120a, may be any electronic device that includes a network stack 124 for communicating over a network 110. Example types of such devices include a camera phone, a personal digital assistant (PDA), a personal computer (PC), a network-enabled camera, and the like.

Each device 120a includes at least one pub/sub client 130, such as a subscriber client, that is configured to communicate with the pub/sub service 220 using a pub/sub communication protocol. In one embodiment, the subscriber client can be a subscription browser, as disclosed in co-pending U.S. patent application Ser. No. 11/160,612 entitled “METHOD AND APPARATUS FOR BROWSING NETWORK RESOURCES USING AN ASYNCHRONOUS COMMUNICATIONS PROTOCOL,” filed on Jun. 30, 2005, and commonly owned with the present application and herein incorporated by reference. The subscription browser 130 makes use of an architecture similar to standard Web browsers, such as MICROSOFT'S INTERNET EXPLORER or MOZILLA FOUNDATION'S FIREFOX, but the subscription browser 130 is further configured to communicate via a pub/sub protocol with the pub/sub service 220. For example, a subscription component 132 can be configured for enabling the subscription browser 130 to communicate with the pub/sub service 220 using a pub/sub protocol. The subscription component 132 can include a pub/sub protocol agent 134 for managing pub/sub commands to and from the pub/sub service 220 and a user interface component 136 for presenting information received from the pub/sub service 220.

According to an exemplary embodiment, the server 200 hosts the pub/sub service 220. As stated above, the pub/sub service 220 is configured to process subscriptions by pub/sub clients 130 to information published by other pub/sub clients 130. In an exemplary embodiment, published information can be stored in tuples in a tuple store 240, and subscription information can be stored in a subscription store 230.

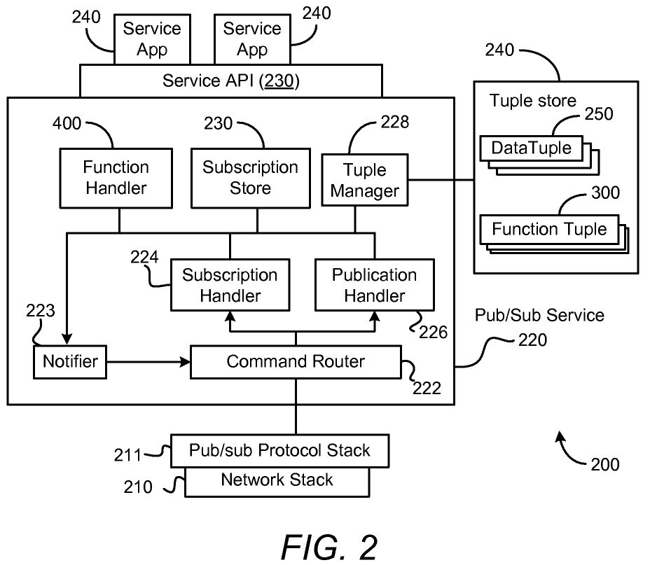

FIG. 2 is an exemplary block diagram of the server 200 according to an exemplary embodiment. The server 200 includes a pub/sub protocol stack component 211 coupled to a network stack component 210. The network stack component 210 is used to exchange information received or transmitted at the physical layer (e.g., the wire, air interface, or fiber optic cable) of the network 110, through the data link (e.g., ETHERNET, 802.11 WIFI), transport/network (e.g., TCP/IP) and application (e.g., XMPP) layers of the stack. The pub/sub protocol stack component 211 processes pub/sub commands received from the network 110 and passes the commands to the pub/sub service 220.

The pub/sub service 220 includes a command router 222 configured to receive and process pub/sub commands from the pub/sub protocol stack component 211. In one embodiment, the command router 222 directs subscribe commands to a subscription handler 224 that is configured to handle subscribe commands, directs publish commands to a publication handler 226 that is configured to handle publish commands, and sends notify commands on behalf of a notifier 223. The command router 222 can also be configured to process other pub/sub commands, such as PROBE and FETCH/POLL.

The subscription handler 224 processes subscribe commands and other tasks associated with subscriptions. In one embodiment, the subscription handler 224 processes a subscribe command by placing the subscribing client 130 on a subscription list associated with the tuple. In addition, the subscription handler 224 authenticates and authorizes the client 130, manages rosters and subscription lists, and uses the notifier 223 to construct notification response messages informing clients 130 when new information is available. The publication handler 226 processes publish commands and coordinates with the subscription handler 224 the publication of tuple data to ensure that subscribing clients 130, if any, are notified via the notifier 223.

In one embodiment, the pub/sub service 220 is configured to host one or more service applications 240 via a service application programming interface (API) 230. Such a configuration is described in co-pending U.S. patent application Ser. No. 11/323,762 entitled “METHOD AND APPARATUS FOR PROVIDING CUSTOMIZED SUBSCRIPTION DATA,” filed on Dec. 30, 2005, and commonly owned with the present application and herein incorporated by reference. In one embodiment, the service API 230 enables the pub/sub service 220 to pass subscription notification messages to any one of the service applications 240. Because the service API 230 is independent of both the transport and pub/sub protocol, messages can be exchanged freely and securely between the pub/sub service 220 and any of the service applications 240.

The pub/sub service 220 also includes a tuple manager 228 for managing data tuples 250, function tuples 300, and published information in the tuples 250, 300. In one embodiment, the tuple manager 228 can be configured also to manage rosters for security purposes and to store and to retrieve tuple data from the tuple store 240. If the pub/sub service 220 archives published information, the tuple manager 228 can also be configured to archive and to retrieve the archived published information.

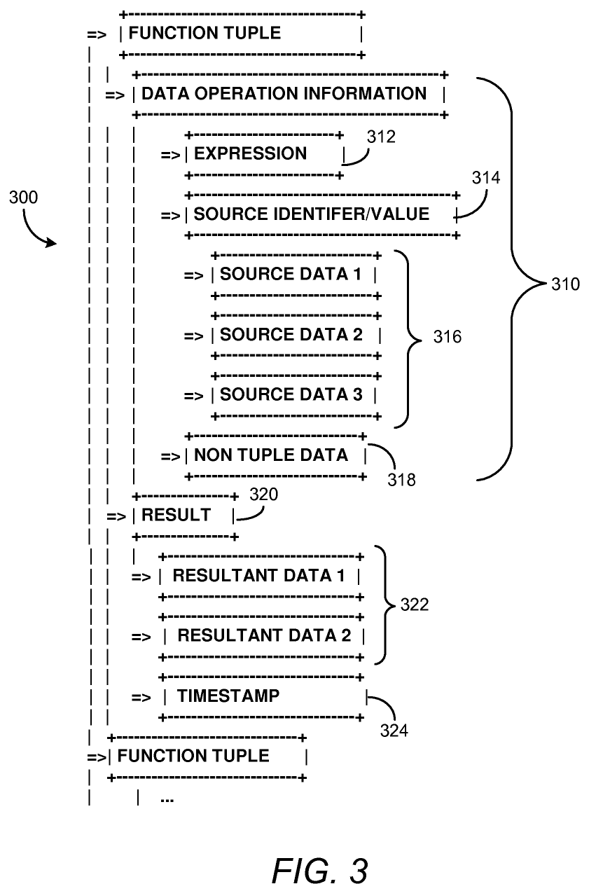

In an exemplary embodiment, the pub/sub service 220 includes means for providing a function tuple 300 that includes data operation information which is configured to operate on at least one source data input. For example, the publication handler 226 described above can be configured to perform this task. FIG. 3 illustrates an exemplary data model of a function tuple 300 according to one embodiment. The function tuple 300 can include a data operation information element 310 and a result element 320. According to an exemplary embodiment, a publisher publishes data operation information to the data operation information element 310 and a subscriber subscribes to the resultant data in the result element 320.

In this embodiment, the data operation information element 310 includes an expression element 312 and a source identifier element 314. In one embodiment, the expression element 312 can include an expression that comprises at least one of an equation, a data transformation, a function, and an algorithm to be performed on one or more source data. The expression can be written in advanced code languages, object orientated code languages, binary code, directly executable files, proprietary code languages, declarative syntax, or limited function sets. The expression can also include identifiers of functions or procedures that are stored on the server 200 and/or within the pub/sub service 220. In addition, the expression can include conditional or logical statements. In one embodiment, the expression element 310 can include an element that indicates whether the expression is private or public, i.e., unavailable or available to subscribers, as well as an element that describes the nature of the code language, e.g., the code language, a format, and a type.

In one embodiment, the source identifier element 314 includes a source data element 316 corresponding to each of the one or more source data referenced in the expression element 312. Each source data element 316 can include an identifier that identifies the tuple 250 associated with the corresponding source data. For example, the identifier can be a uniform resource identifier (URI), a uniform resource locator (URL), or an address of the tuple 250 associated with the source data, which is not limited to a numerical value, but can include textual, coded, or multimedia data.

In one embodiment, the information in the source data element 316 is provided by the publisher when the data operation information 310 is published to the function tuple 300. In another embodiment, the source data element 316 can include a data type of the source data, and a subscriber to the function tuple 300 can be allowed to provide a source data identifier. For example, during a subscription process, the subscriber can submit subscription information that includes the identifier for at least one tuple 250 that includes source data having the data type prescribed by the function tuple 300. In this manner, the function tuple 300 can be semi-customized to the subscriber.

In one embodiment, the source data element 316 can also include an element for storing a current value of the source data and optionally a timestamp. Storing the current value of the source data in the function tuple 300 can be advantageous when the expression processes a plurality of source data inputs and only a portion of the source data inputs are updated. Here, the current values of unchanged source data inputs need not be fetched from the tuple store 240 because they are immediately available in the function tuple 300.

In another embodiment, the expression can reference non tuple data, as well as tuple data. For example, the current date and time, as provided by the server 200, can be used as input data in addition to tuple data for the execution of the expression specified by a function tuple 300. In this case, the process data operation information element 310 can include a non tuple data element 318 for storing the non tuple input data.

According to an exemplary embodiment, the function tuple 300 also includes a result element 320 that comprises one or more resultant data elements 322, and optionally, a timestamp element 324. The resultant data elements 322 include the result of the expression in the expression element 312 based on the current source data inputs. As an optional feature, the timestamp element 324 can store a timestamp indicating when the resultant data 222 was last updated. Storing the resultant data in the function tuple 300 as a tuple element allows the subscription to and notification of that resultant data to subscribers in a conventional manner as if it was a conventional data tuple.

The function tuple 300 shown in FIG. 3 and described above is an exemplary data model. Those skilled in the art would readily recognize that the function tuple 300 can, and most likely would, include additional elements and/or sub-tuples. For example, the function tuple 300 can include a status element and contact information, as well as other information. In another example, the function tuple 300 can include more than one expression element 312 and result elements 320 corresponding to each expression element 312. Accordingly, the description above should not be interpreted as limiting the structure of the function tuple 300.

Referring again to FIG. 2, in one embodiment, the pub/sub service 220 includes a means for providing a subscription by a subscriber to the function tuple 300. In one embodiment, the subscription handler 224, described above, can be configured perform this function. In addition, according to an exemplary embodiment, the pub/sub service 220 includes a function handler 400 for processing and managing the function tuples 300. In one embodiment, the function handler 400 can be configured to support any particular function tuple 300 based on the tuple data provided in the function tuple 300. In another embodiment, a function handler 400 can be instantiated for each function tuple 300 such that the function handler 400 is customized to the function tuple 300.

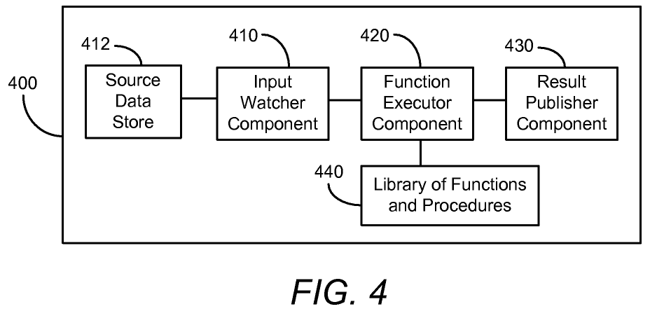

FIG. 4 is a block diagram illustrating an exemplary function handler 400 according to one embodiment. The function handler 400 includes means for initiating a subscription by a function tuple 300 to a tuple 250 that includes source data, means for receiving a notification indicating an update of the source data, and means for generating resultant data using the data operation information of the function tuple 300 to process at least the updated source data.

For example, the function handler 400 can include an input watcher component 410 that is configured to initiate subscriptions by the function tuple 300 to the one or more tuples 250 that include source data. In one embodiment, the input watcher component 410 can subscribe the function tuple 300 to another function tuple 300 when the source data is the resultant data of the other function tuple 300. In addition, the input watcher component 410 can subscribe the function tuple 300 to tuples 250, 300 that are managed by the same pub/sub service 220 or by another pub/sub service 220 on another server 200.

In one embodiment, the input watcher component 410 can be configured to send, on behalf of the function tuple 300, a subscribe command that identifies the tuple 250 to a subscription handler 224, which places the function tuple 300 on the subscription list associated with the tuple 250. In one embodiment, the tuple 250 and the function tuple can be managed by the same pub/sub service 220, and therefore, the communication between the input watcher component 410 and the subscription handler 224 can be internal. In another embodiment, the tuple 250 and the function tuple 300 can be managed by different pub/sub services 220 on the same or separate servers 200. Here, the subscription handler 224 managing the subscribe command from the input watcher component 410 would be that which resides in the pub/sub service 220 managing the tuple 250.

Once the function tuple 300 is subscribed, the input watcher component 410 can be configured to watch for updates to the tuple 250 on behalf of the function tuple 300. When the source data in the tuple 250 is updated, the input watcher component 410 receives a notification message and the updated source data from the notifier 223 associated with the pub/sub service 220 managing the tuple 250. In one embodiment, the input watcher component 410 can be configured to cache or store the current source data, including updated source data, of a function tuple 300 in a source data store 412. In this manner, the source data can be immediately available to the function handler 400.

In an exemplary embodiment, the function handler 400 also includes a function executor component 420 that is configured to generate resultant data using the data operation information of a function tuple 300 to process the current source data inputs, which can include updated source data. In one embodiment, the function executor component 420 is configured to interpret the function code, script, or commands in the expression element 312 of the function tuple 300, and to apply the expression to the source data inputs 316, which can be stored in the function tuple 300 (as described above) or in the source data store 412 associated with the function handler 400.

In one embodiment where the function handler 400 supports a plurality of function tuples 300, the function executor component 420 can be configured to interpret expressions of various types, formats, and code languages. In addition, the function executor component 420 can be configured to compile, as well as execute the program code. In an exemplary embodiment, a library of functions and procedures 440 can be provided that stores a plurality of compiled programs and/or procedures that can be called and executed. Based on the information in the expression element 312 of the function tuple 300, which can include identifiers of functions or procedures stored in the library 440 or elsewhere on the server 200, the function executor component 420 can retrieve a particular function or procedure from the library 440 to execute the expression.

According to an exemplary embodiment, the function handler 400 also includes a result publisher component 430 that is configured to publish the resultant data to the result element 320 of the function tuple 300 via the publication handler 226. In one embodiment, the result publisher component 430 can send a publish command to the publication handler 226, which stores the updated resultant data in the result element 320 of the designated function tuple 300. In another embodiment, the result publisher component 430 is also configured to publish the updated source data to the corresponding source data element 316 of the function tuple 300. Here, the updated source data can be published when the resultant data is published, or when the input watcher component 410 receives the notification message that includes the updated source data.

According to an exemplary embodiment, the result publisher component 430 can publish the resultant data to the function tuple 300 at various times. For example, the resultant data can be published when the function tuple 300 is initially provided, i.e., when the data operation information 310 is first published. In addition, the resultant data can be published when updated source data is received.

In one embodiment, the pub/sub service 220 includes a means for generating a notify message that includes the resultant data. For example, the notifier 223, described above, can be configured to generate the notify message including the resultant data when the resultant data is published to the function tuple 300.

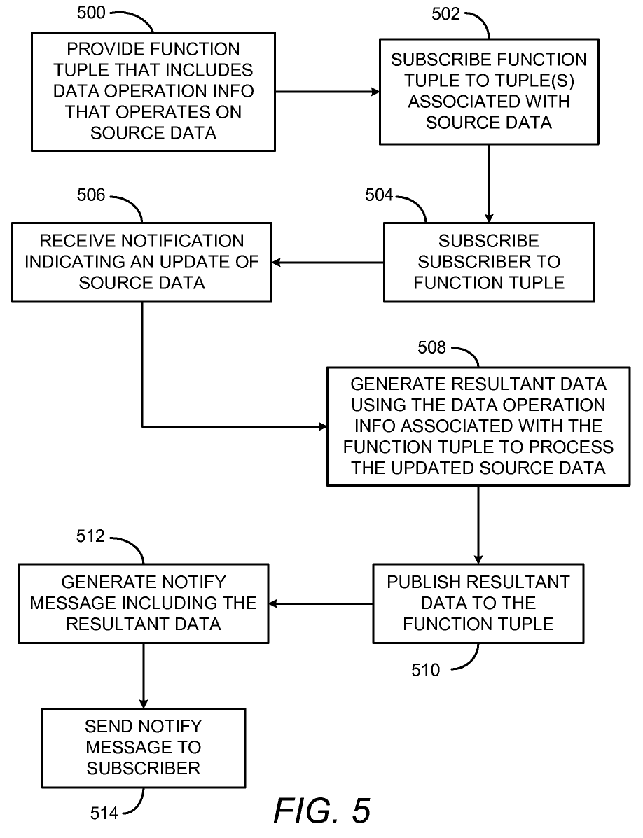

FIG. 5 is a flow diagram illustrating a method for performing data operations using a pub/sub service according to an exemplary embodiment. Referring to FIGS. 1-4, and 5, the method begins by providing a function tuple 300 that includes data operation information which is configured to operate on a source data input (block 500). In one embodiment, a publisher client, e.g., 120a, publishes data operation information to an existing or new function tuple 300 managed by the pub/sub service 220 via a publish command. The publication handler 226 receives the publish command and stores the data operation information in the data operation information element 310 of the function tuple 300.

In an exemplary embodiment, the publication handler 226 is configured to pass the updated or new function tuple 300 to the function handler 400, which invokes the input watcher component 410 to subscribe the function tuple 300 to a tuple 250 that includes the source data (block 502). In one embodiment, the input watcher component 410 is configured to initiate the subscription process on behalf of the function tuple 300 by sending a subscribe command to the subscription handler 224 associated with the pub/sub service 220 that manages the tuple 250 that includes the source data. Note that the tuple 250 can be managed by the same pub/sub service 220 that manages the function tuple 300 or by another pub/sub service 220 in another server 200. The subscription handler 224 associated with the tuple 250 is configured to process the subscribe command and stores the subscription information in the subscription store 230. Once the subscription process is completed by the function handler 400, the function tuple 300 is stored in the tuple store 240.

According to an exemplary embodiment, the subscription handler 224 is further configured to subscribe a subscriber to the function tuple 300 (block 504). In one embodiment, the subscription handler 224 receives a subscribe command from the subscriber client, e.g., 120b, and subscribes the subscriber 120b to the result element 320, including the resultant data element(s) 322, of the function tuple 300. Optionally, the subscription handler 224 can invoke the notifier 223, which sends a notification message to the subscriber 120b. The notification message confirms the subscription and includes the current tuple data associated with the subscription, i.e., the resultant data element 322 of the function tuple 300.

In another embodiment, mentioned above, the source data element 316 of the function tuple 300 can include a data type of the source data, and the subscriber 120b to the function tuple 300 can be allowed to provide a source data identifier during the subscription process. In this embodiment, the subscription information can be stored by the subscription handler 224 in the subscription store 230 and associated with the function tuple 300.

In one embodiment, when the publication handler 226 receives a publish command that includes updated source data from another publisher client 120c, it replaces the source data in the tuple 250 with the updated source data. The publication handler 226 informs the subscription handler 224 of the update and the subscription handler 224 determines which subscribers are subscribed to the tuple 250. The subscription handler 224 utilizes the notifier 223 to send notification messages including the updated source data to the subscribers, including an input watcher component 410 associated with a subscribed function tuple 300.

The input watcher component 410 receives, pursuant to its subscription, the notification indicating the update and including the updated source data (block 506). In one embodiment, the input watcher component 410 can store the updated source data in the source data store 412 or in another data store in the server 200, so that the most current value of the source data is immediately available to the function handler 400.

In one embodiment, where the function handler 400 supports a plurality of function tuples 300, the input watcher component 410 is configured to identify the function tuple 300 that refers to the source data based on the subscription to the tuple 250. In another embodiment, where each function tuple 300 is associated with a function handler 400, identifying the function tuple 300 is not necessary. In either case, the input watcher component 410 can be configured to pass the updated source data to the result publisher component 430, which can publish the updated source data to the source data element 316 of the identified or associated function tuple 300.

In an exemplary embodiment, when the notification is received, the input watcher component 410 is configured to trigger the function executor component 420, which generates resultant data using the data operation information of the function tuple 300 to process at least the updated source data (block 508). In one embodiment, the function executor component 420 can interpret the expression in the expression element 312 of the function tuple 300 and apply the expression to the source data, including the updated source data. The source data can be retrieved from the function tuple 300 or from the source data store 412 or from another source, such as a clock mechanism on the server 200.

After the resultant data is generated, the result publisher component 430 publishes the resultant data to the result element 320 of the function tuple 300 (block 510). In one embodiment, the result publisher component 430 is configured to send a publish command including the resultant data to the publication handler 226. In another embodiment, the result publisher component 430 can also publish the updated source data to the source data element 316 of the function tuple 300 along with the resultant data.

In an exemplary embodiment, the publication handler 226 receives the publish command and stores the resultant data, and optionally, the updated source data, in the function tuple 300. In addition, the publication handler 226 indicates to the subscription handler 224 that the function tuple 300 includes updated tuple data. The subscription handler 224 identifies the subscriber 120b to the function tuple 300 and utilizes the notifier 223 to generate a notify message including the resultant data (block 512). The notify message is then sent to the subscriber 120b (block 514) pursuant to its subscription to the function tuple 300.

In one embodiment, the subscriber 120b is subscribed to the result element 320 of the function tuple 300. Accordingly, the subscriber 120b receives only the resultant data whenever the function executor component 420 executes the expression and the result publisher component 430 publishes the resultant data to the function tuple 300. In another embodiment, the subscriber 120b can subscribe to other elements of the function tuple 300, such as the expression element 312 or the source data element(s) 316, in addition to the result element 320. Thus, the subscriber 120b can receive the expression and the source data inputs.

In another embodiment, the subscriber need not be a client 120b, but can be a tuple, such as a second function tuple 300. In this case, the resultant data of a first function tuple 300 can be one of the source data inputs of the second function tuple 300. The second function tuple 300 and the first function tuple 300 can be managed by the same or by different pub/sub services 200. The input watcher component 410 associated with the pub/sub service 200 managing the second function tuple 300 receives, pursuant to a subscription by the second function tuple 300 to the first function tuple 300, the notify message including the resultant data. The associated function executor component 420 executes the expression of the second function tuple 300 using the resultant data of the first function tuple 300, and the associated result publisher component 430 publishes the new resultant data to the second function tuple 300.

The following examples are provided to illustrate how the pub/sub service 200 can be used to perform data operations according to an exemplary embodiment.

### EXAMPLE 1

### Media Player Status

The status of a media player, e.g., a DVD player, can be provided through a presence service, including the media the player is playing and where in the media stream the player currently is. When a media playing event occurs, such as a user pushing “play” on the DVD player, the player could automatically publish a function tuple 300. The function tuple 300 could include the media title and/or identification information, the current playing state of the player (e.g. play-mode), the media track structure, the time that the play-button was pushed, and an expression describing how the media tracks and timer of the media playing is counted.

Based on this information, the function tuple 300 can automatically update itself to give an accurate status of the media player's media playing. For example, when a DVD is playing, the media timer can be updated every second until the end of a track is reached, at which point the track can be incremented and the timer can be reset. As soon as a Pause, Stop, FFW, or RW action is initiated on the player by the user, a new function tuple 300 can be published replacing the previous one. For example, if the FFW button was pushed, the new tuple would be similar to the previous one associated with the play-state, except that the media timer status would be automatically updated twice as fast.

Alternatively, separate tuples for the states of the media player can be provided, i.e., one tuple could provide the name or identifying information regarding the media, one could provide the playing status (Play, FFW, etc), and one could be a function tuple 300 that uses the information of the other tuples to determine and provide the location in the particular media stream the player is. With both of these solutions, the media player is not required to update its track and media timer status every second (in Play mode), as the function tuple 300 can update itself based on the expression provided by the player. In this sense, the function tuple 300 can be a self-updating tuple, where the expression is a time-based function.

### EXAMPLE 2

### Media Transformation

Image data can be provided through a presence or pub/sub service, where pictures are automatically delivered to subscribers when the picture(s) are updated through the presence or pub/sub service. A function tuple 300 could be provided that re-formats the images. The function tuple 300, when published, subscribes to the image-sharing tuple. When new images are published to the image-sharing tuple, the function tuple 300 receives proper notification of the new image(s). Upon receiving the new image-sharing tuple data, the function tuple 300 performs its function on the new image(s), and provides the result(s) to the subscriber(s) of the function tuple 300.

The function tuple 300 could perform a transformation on the input image(s), such as changing the resolution or image size, cropping the image, color balancing the image, removing red-eyes from the image, etc. In addition, the function tuple 300 can incorporate other input sources in addition to the single image-sharing tuple. The function tuple 300 can subscribe to numerous image-sharing tuples as input sources, and provide to the subscriber(s) of the function tuple 300 a collage of all of the images in the image-sharing tuples subscribed to by the function tuple 300.

### EXAMPLE 3

### Random Number Generator

The function tuple 300 can include a random number generation function, where the source data input values act as seed values for the function. The result is a random value.

According to aspects of the exemplary embodiments, the function tuple 300 is subscribed to receive notifications of updates to source data in substantially real time. In turn, the expression is executed, the result is published, and notification is sent to the subscriber 120b in substantially real time. Accordingly, the subscriber 120b can receive up-to-date information, pursuant to its subscription, without polling.

In addition, the data processing function can be centralized at the pub/sub service 220 thereby eliminating extraneous steps and communication sessions between pub/sub service 220 and its clients 120 and redundant processing by multiple clients 120. In an exemplary embodiment, the publisher client 120a who provides the data operation information is not necessarily the publisher 120c who provides the source data. Thus, when the source data is private information, aspects of the source data can be made public through abstraction functions. In another aspect, because the expression and the result reside in the same tuple, deployment, subscription, and use are simplified. Moreover, the existing infrastructure of the pub/sub service can be utilized to provide data management, security, privacy, account management, and data storage.

The executable instructions of a computer program for carrying out the methods illustrated in FIG. 5 can be embodied in any machine or computer readable medium for use by or in connection with an instruction execution machine, system, apparatus, or device, such as a computer-based or processor-containing machine, system, apparatus, or device, that can read or fetch the instructions from the machine or computer readable medium and execute the instructions.

As used here, a “computer readable medium” can be any means that can contain, store, communicate, propagate, or transport the computer program for use by or in connection with the instruction execution machine, system, apparatus, or device. The computer readable medium can be, for example, but not limited to, an electronic, magnetic, optical, electromagnetic, infrared, or semiconductor machine, system, apparatus, device, or propagation medium.

More specific examples (a non-exhaustive list) of the computer readable medium can include the following: a wired network connection and associated transmission medium, such as an ETHERNET transmission system, a wireless network connection and associated transmission medium, such as an IEEE 802.11(a), (b), or (g) or a BLUETOOTH transmission system, a wide-area network (WAN), a local-area network (LAN), the Internet, an intranet, a portable computer diskette, a random access memory (RAM), a read only memory (ROM), an erasable programmable read only memory (EPROM or Flash memory), an optical fiber, a portable compact disc (CD), a portable digital video disc (DVD), and the like.

It will be appreciated by those of ordinary skill in the art that the concepts and techniques described here can be embodied in various specific forms without departing from the essential characteristics thereof. The presently disclosed embodiments are considered in all respects to be illustrative and not restrictive. The scope of the invention is indicated by the appended claims, rather than the foregoing description, and all changes that come within the meaning and range of equivalence thereof are intended to be embraced.

What is claimed is:

1. A method for performing data operations using a publish/subscribe service, the method comprising:
providing a first tuple that includes data operation information that is configured to operate on a source data;
providing for a first subscription by the first tuple to a second tuple that includes the source data;
providing for a second subscription by a subscriber to the first tuple;
receiving, pursuant to the first subscription, a notification indicating an update of the source data of the second tuple, the notification including the updated source data;
in response to receiving the notification, generating resultant data using the data operation information of the first tuple to process at least the updated source data of the second tuple; and
generating a notify message including the resultant data.

2. The method of claim 1 further including sending the notify message including the resultant data to the subscriber pursuant to the second subscription to the first tuple.

3. The method of claim 1 wherein providing the second subscription to the first tuple includes subscribing the subscriber to a result element in the first tuple.

4. The method of claim 3 wherein prior to generating the notify message, the method further includes publishing the resultant data to the result element in the first tuple such that the subscriber receives a notification indicating an update of the resultant data in the result element in the first tuple.

5. The method of claim 1 wherein providing the first tuple comprises receiving a command to publish data operation information in the first tuple.

6. The method of claim 1 wherein the data operation information includes at least one of an equation, a data transformation, a function, and an algorithm, and an identifier for at least one source of the source data, wherein the identifier includes at least one of a uniform resource identifier (URI), a locator, and an address of a tuple that includes source data.

7. The method of claim 6 wherein the data operation information further includes a reference to non-tuple data.

8. The method of claim 1 wherein the data operation information is configured to operate on a plurality of source data.

9. The method of claim 8 further comprising providing for a plurality of subscriptions by the first tuple to a plurality of tuples that include the plurality of source data referenced in the data operation information.

10. The method of claim 8 further comprising storing a current value for each of the plurality of source data in at least one of the first tuple and a data store.

11. The method of claim 8 wherein generating the resultant data includes applying the data operation information to the plurality of source data including the updated source data.

12. The method of claim 1 further comprising:
providing for a third subscription by a third tuple to the first tuple, the third tuple including data operation information;
receiving, pursuant to the third subscription to the first tuple, the notify message including the resultant data of the first tuple;
in response to receiving the notify message, using the data operation information of the third tuple to process the resultant data of the first tuple to generate another resultant data value; and
generating another notify message including the another resultant data value.

13. The method of claim 1 wherein the data operation information in the first tuple refers to a data type for the source data and wherein providing for the second subscription to the first tuple includes:
receiving subscription information from the subscriber, the subscription information including an identifier for at least one source of source data, wherein the identifier includes one of a uniform resource identifier (URI), a locator and an address of a tuple that includes source data of the data type specified.

14. A computer readable medium containing a computer program, executable by a machine, for performing data operations using a publish/subscribe service, the computer program comprising executable instructions for:
providing a first tuple that includes data operation information that is configured to operate on a source data;
providing for a first subscription by the first tuple to a second tuple that includes the source data;
providing for a second subscription by a subscriber to the first tuple;
receiving, pursuant to the first subscription, a notification indicating an update of the source data of the second tuple, the notification including the updated source data;
in response to receiving the notification, generating resultant data using the data operation information of the first tuple to process at least the updated source data of the second tuple; and
generating a notify message including the resultant data.

15. The computer readable medium of claim 14 further including instructions for sending the notify message including the resultant data to the subscriber pursuant to the second subscription to the first tuple.

16. The computer readable medium of claim 14 further comprising instructions for subscribing the subscriber to a result element in the first tuple.

17. The computer readable medium of claim 16 further including instructions for publishing the resultant data to the result element in the first tuple.

18. The computer readable medium of claim 14 further comprising instructions for receiving a command to publish data operation information in the first tuple, wherein the data operation information includes at least one of an equation, a data transformation, a function, and an algorithm, and an identifier for at least one source of source data, wherein the identifier includes one of a uniform resource identifier (URI), a locator, and an address of a tuple that includes source data.

19. The computer readable medium of claim 14 further comprising instructions for providing for a plurality of subscriptions by the first tuple to a plurality of tuples that include a plurality of source data when the data operation information is configured to operate on a plurality of source data.

20. The computer readable medium of claim 19 further comprising instructions for storing a current value for each of the plurality of source data in at least one of the first tuple and a data store.

21. The computer readable medium of claim 19 further comprising instructions for applying the data operation information to the plurality of source data including the updated source data.

22. The computer readable medium of claim 14 further comprising instructions for:
providing for a third subscription by a third tuple to the first tuple, the third tuple including data operation information;
receiving, pursuant to the third subscription to the first tuple, the notify message including the resultant data of the first tuple;
in response to receiving the notify message, using the data operation information of the third tuple to process the resultant data of the first tuple to generate another resultant data value; and
generating another notify message including the another resultant data value.

23. A system for performing data operations using a publish/subscribe service, the system comprising:
a publication handler configured for providing a first tuple that includes data operation information that is configured to operate on a source data;
an input watcher component configured for initiating a first subscription by the first tuple to a second tuple that includes the source data and for receiving, pursuant to the first subscription, a notification indicating an update of the source data of the second tuple, the notification including the updated source data;
a subscription handler configured for providing for a second subscription by a subscriber to the first tuple;
a function executor component configured for generating, in response to receiving the notification, resultant data using the data operation information of the associated first tuple to process at least the updated source data of the second tuple; and
a notification handler for generating a notify message including the resultant data.

24. The system of claim 23 wherein the notification handler is configured for sending the notify message including the resultant data to the subscriber pursuant to the second subscription to the first tuple.

25. The system of claim 23 wherein the subscription handler is configured for subscribing the subscriber to a result element in the first tuple.

26. The system of claim 25 further comprising a result publisher component configured for publishing the resultant data to the result element in the first tuple.

27. The system of claim 23 wherein the publication handler is further configured for receiving a command to publish data operation information in the first tuple, wherein the data operation information includes an expression comprising at least one of an equation, a data transformation, a function, and an algorithm, and an identifier for at least one source of source data, wherein the identifier includes one of a uniform resource identifier (URI), a locator, and an address of a tuple that includes source data.

28. The system of claim 23 wherein the data operation information is configured to operate on a plurality of source data.

29. The system of claim 28 wherein the input watcher component is configured for initiating a plurality of subscriptions by the first tuple to a plurality of tuples that include the plurality of source data referenced in the data operation information and for storing the current value for each of the plurality of source data in a data store.

30. The system of claim 28 wherein the result publisher component is configured for publishing a current value for each of the plurality of source data in the first tuple.

31. The system of claim 28 wherein the function executor component is configured for applying the data operation information to the plurality of source data, including the updated source data.

32. The system of claim 23 wherein the subscription handler is configured for providing for a third subscription by a third tuple to the first tuple, the third tuple including data operation information, wherein the notification handler is configured for sending, pursuant to the third subscription to the first tuple, another notify message including the resultant data of the first tuple.

33. The system of claim 23 wherein the data operation information in the first tuple refers to a data type for the source data and wherein the subscription handler is configured for receiving subscription information from the subscriber, the subscription information including an identifier for at least one source of source data, wherein the identifier includes one of a uniform resource identifier (URI), a locator, and an address of a tuple that includes source data.

34. A system for performing data operations using a publish/subscribe service, the system comprising:
means for providing a first tuple that includes data operation information configured to operate on a source data;
means for providing for a first subscription by a subscriber to the first tuple;
means for initiating a second subscription by the first tuple to a second tuple that includes the source data and for receiving, pursuant to the second subscription, a notification indicating an update of the source data of the second tuple, the notification including the updated source data;
means for generating, in response to receiving the notification, resultant data using the data operation information of the associated first tuple to process at least the updated source data of the second tuple; and
means for generating a notify message including the resultant data.
